(19) United States
(12) Patent Application Publication
(10) Pub. No.: US 2015/0254342 A1
(43) Pub. Date: Sep. 10, 2015

(54) VIDEO DNA (VDNA) METHOD AND SYSTEM FOR MULTI-DIMENSIONAL CONTENT MATCHING

(71) Applicants: Lei Yu, Hangzhou (CN); Yangbin Wang, Palo Alto, CA (US); Xiaozhi Liu, Hangzhou (CN)

(72) Inventors: Lei Yu, Hangzhou (CN); Yangbin Wang, Palo Alto, CA (US); Xiaozhi Liu, Hangzhou (CN)

(21) Appl. No.: 14/722,653

(22) Filed: May 27, 2015

Related U.S. Application Data
(63) Continuation-in-part of application No. 13/118,516, filed on May 30, 2011.

(51) Int. Cl. G06F 17/30

(52) U.S. Cl. CPC G06F 17/30784; G06F 17/30858

(57) ABSTRACT

A method and system of identifying and matching content characteristics comprises the steps of ingesting VDNA (Video DNA) fingerprints from input media contents, quick hash-based query across the VDNA registered indexer servers, and performing multi-dimensional content identification in query engines to obtain best matched results of the input media content.

### CROSS-REFERENCE TO RELATED APPLICATIONS

The present application is a continuation-in-part of U.S. application Ser. No. 13/118,516, filed May 30, 2011, entitled “VIDEO DNA (VDNA) METHOD AND SYSTEM FOR MULTI-DIMENSIONAL CONTENT MATCHING” and which is incorporated herein by reference and for all purposes.

### BACKGROUND OF THE INVENTION

1. Field of the Invention

The present invention relates to a method and system for identifying and tracking media contents, including Video DNA (VNDA) fingerprints ingestion from media contents, VDNA hash-based query from index engine and multi-dimensional content identification in query engine. Specifically, the present invention relates to facilitating accurately and fast identification of media contents.

2. Description of the Related Art

Media contents sharing on the Internet has been through a tremendous boost in recent years, websites hosting video contents are becoming so popular that they even take over a very large proportion of the Internet traffic. Present online media contents are easily accessible via different terminals, from personal computers, tablets, mobile devices etc, and different channels such as online video websites which are authorized by content owners, UGC (User Generated Content) websites, P2P (Point-to-Point) networks and so on.

Some of the distinct characteristics of online media contents include a) massive distribution amount, b) multiple content sources, c) high speed propagation over the whole network, and d) rapid updates of the contents, which make it a tough challenge for content owners attempting to protect and track the usage of their contents on the Internet. Although it is a trend that content owners apply Internet and online media sites or terminals as one of their content distribution channels, there are a number of issues they concern which have no significant solutions by conventional methods as in traditional video content distribution channels. Such issues that content owners concern include:
illegal copies of video contents propagating on the Internet, on unauthorized sites or terminals;
audience rating of the video contents is not as visible as contents distributed via traditional channels, e.g. box office, DVD (digital versatile disc or digital video disc) sales report, etc;
audience preferences over the video contents, or even certain parts of the video content, are valuable data which content owners may be interested.

On the top of the above said issues, illegal copies of video contents are seen mostly on UGC websites and P2P networks. UGC websites are protected by safe harbor of the DMCA (Digital Millennium Copyright Act), in order to protect video contents, content owners are required to discover illegal contents presented on UGC websites and post take down notices.

Conventional method of searching and discovering video content copies includes:
using keywords to search in search engines, analyzing from search results based on keywords or tags;
search by keywords or tags in video contents sharing websites or UGC websites, analyzing from search results based on keywords or tags;
using digital watermarks on all registered video contents, and discover by matching the digital watermarks.

There are several disadvantages about this method:
1. keywords or tags search is semantics based, which works fine with documents or information described by texts, yet it has weak accuracy as to identify video contents;
2. such searching and discovering method cannot provide sufficient evidence to demand UGC websites to take down illegal copies of contents;
3. embedding digital watermarks break the integrity of the original video contents.

Although there are some means to help to improve the disadvantages mentioned above, yet most of them require human operations intervened, for example to increase the accuracy of video identification from the text based search results, they are required to manually check the contents of the video, which determines that such methods are not scalable, let alone to optimize with limited resources to handle massive amount of information on the Internet.

Ways to automatically identify and track the video contents is hence desirable, so that no or few human operations are involved in the whole process. With the help of a mature media fingerprinting technology, given required content and metadata from content owners, the system is able to identify any number or format of media contents.

### SUMMARY OF THE INVENTION

An object of the invention is to overcome at least some of the drawbacks relating to the prior arts as mentioned above.

An object of the present invention is to automatically identify media contents, by using VDNA fingerprints and combination of multiple optimization techniques, it is possible to match input media content with the registered content in a fast and accurate way. The present invention comprises steps of ingesting VDNA fingerprints from input media contents, quick hash-based query across VDNA registered index engine, and performing multi-dimensional content identification in query engines to obtain best matched results of the input media content.

Conventional fingerprinting belongs to the so-called watermarking method or non-content based method (such as enforcement data, protection code, etc which are added into the content), where arbitrary information (or called fingerprint to some extend) is hidden into the original content. In watermarking, the “Watermark” (also called “fingerprint”) is the additional information to be inserted into the image/video/audio content and it is independent of the image/video/audio content. However in the present invention, the fingerprint is deterministically extracted based on the content.

The ingestion of fingerprints out from media contents takes advantage of the high speed processing of the computers to ingest characteristic values of each frame of image and audio from media contents, as is called “VDNA or Video DNA”, which are registered in VDDB (video DNA database) for reference and query. Such process is similar to collecting and recording human fingerprints. One of the remarkable uses of VDNA technology is to rapidly and accurately identify media contents, so that to protect copyright contents from being illegally used on the Internet.

Due to the fact that VDNA technology is entirely based on the media content itself, which means in between media content and generated VDNA, there is an one-to-one mapping relationship. Compared to the conventional method of using digital watermark technology to identify video contents, VDNA technology does not require to pre-process the media content to embed watermark information. VDNA technology greatly adapts the characteristics of current online media contents: massive distribution amount, multiple content sources, high speed propagation over the whole network, and rapid updates of the contents, making it much easier and more effective for content owners to track their registered contents over the Internet.

Based on statistical research on the matching rates of key frames between input media contents and master media contents, it can be concluded that given only a set of sampled fingerprints ingested from the input media content, it is highly possible to get a list of candidate matched master content ranked by hit-rate of similarity, if all master media contents are fingerprinted and indexed beforehand. This is the optimization idea behind index servers. Using index server to pre-process the input media content can save a lot of processing efforts by rapidly generating best matched media candidate list instead of thoroughly comparing every master media contents in detail at the first place.

The basic building block of VDNA fingerprint identification algorithm is calculation and comparison of Hamming Distance of fingerprints between input and master media contents. A score will be given after comparing input media content with each of top ranked media contents outputted by index server. A learning-capable mechanism will then help to decide whether or not the input media content is identified with reference to the identification score, media metadata, and identification history.

In order to optimize the speed and accuracy of content identification, some methods are applied also in this process, such as using triangle principle to predict some special matching scenarios, and adding timeline information or other dimensional information to improve content matching accuracy.

In summary, the present invention takes advantage of the properties of computers: high speed, automatic, huge capacity and persistent, and identifies input media contents from registered media contents which makes it possible for content owners to automatically, accurately and rapidly protect registered media contents online.

In other aspect, the present invention also provides a system and a set of methods with features and advantages corresponding to those discussed above.

All these and other introductions of the present invention will become much clear when the drawings as well as the detailed descriptions are taken into consideration.

### BRIEF DESCRIPTION OF THE DRAWINGS

For the full understanding of the nature of the present invention, reference should be made to the following detailed descriptions with the accompanying drawings in which:

FIG. 1 shows schematically a component diagram of each functional entity in the system according to the present invention.

FIG. 2 is a flow chart showing a number of steps in the index process according to the present invention.

FIG. 3 is a flow chart showing a number of steps in the content query process according to the present invention.

FIG. 4 demonstrates applying multiple dimensional information to improve content identification.

FIG. 5 is basic logic of Triangle Principle.

FIG. 6 is an application of Triangle Principle in query engines in a VDNA system.

FIG. 7 illustrates possible optimization of pre-calculated distances among master VDNA fingerprints in actual implementation.

Like reference numerals refer to like parts throughout the several views of the drawings.

### DESCRIPTION OF THE PREFERRED EMBODIMENT

The present invention now will be described more fully hereinafter with reference to the accompanying drawings, in which some examples of the embodiments of the present inventions are shown. Indeed, these inventions may be embodied in many different forms and should not be construed as limited to the embodiments set forth herein; rather, these embodiments are provided by way of example so that this disclosure will satisfy applicable legal requirements. Like numbers refer to like elements throughout.

Conventional fingerprinting belongs to the so-called watermarking method or non-content based method (such as enforcement data, protection code, etc which are added into the content), where arbitrary information (or called fingerprint to some extend) is hidden into the original content. In watermarking, the “Watermark” (also called “fingerprint”) is the additional information to be inserted into the image/video/audio content and it is independent of the image/video/audio content. However in the present invention, the fingerprint is deterministically extracted based on the content.

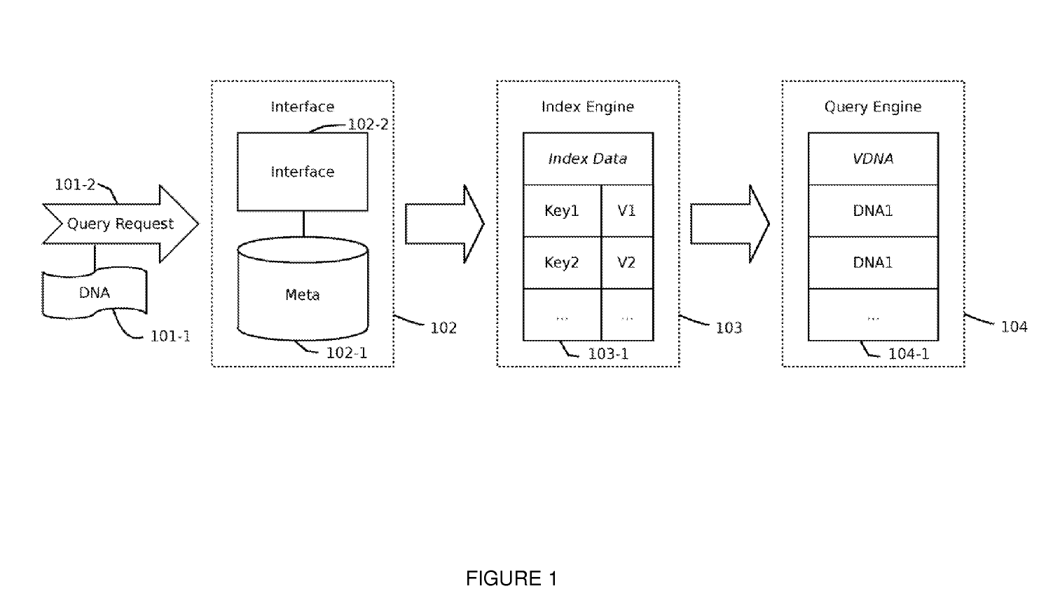

FIG. 1 illustrates main functional components of the VDDB system, in which component 102 represents the interface of the system. The interface can be of any form according to user's requirements, such as http (hypertext transfer protocol) request interface, application programming interface, or customized protocols via socket, etc.

The interface accepts media content query requests, which comes along with ingested VDNA fingerprints of the input media content. The input media contents can be of any format of audio, video or image contents, which will be processed by dedicated VDNA ingestion tool, so that a set of VDNA fingerprints are ingested from the contents. The VDNA ingestion algorithm can be various and different. Take image content as an example, the ingestion algorithm can be as simple as the following a) divide the input image into certain amount of equal sized squares, b) compute average value of the RGB (red, green, blue) values from each pixel in each square, c) in this case the VDNA fingerprint of this image is the 2 dimensional vector of the values from all divided squares. The smaller a square is divided, the more accurate the fingerprint can achieve, yet at the same time it will consume more storage. In more complex version of the VDNA ingestion algorithm, other factors such as brightness, alpha value of the image, image rotation, clipping or flipping of the screen, or even audio fingerprint values will be considered.

The interface component is also equipped with a database of metadata information (102-1) of all registered media contents. When providing content query requests, the users can also provide metadata of the input media content, and the interface can perform first stage simple filtration based on the provided metadata, such as media type, etc.

Component 103 represents the index engine of the system, although drawn in FIG. 1 as one component, actually it can be a cloud of distributed index engines cooperating together. Since the number of registered media contents can be very different according to the requirement of content owners, the design of whole system needs to be highly scalable. Block 103-1 shows the core component inside the index engine, or distributed index engines, which stores a key-value mapping where the keys are hashed VDNA fingerprints of the registered master media content and the values are the identifier of the registered master media content. When user triggers a query request, a set of VDNA fingerprints of the input media content is submitted. Then a pre-defined number of VDNA fingerprints are sampled from the submitted data. The sampled fingerprints are in turn hashed by using the same algorithm as those registered VDNA fingerprints were hashed, and using these hashed sampled fingerprints to get the values in the registered mapping. Based on statistical research on the matching rates of key frames between input media contents and master media contents, it can be concluded that given only a set of sampled fingerprints ingested from the input media content, it is highly possible to get a list of candidate matched master content ranked by hit-rate of similarity. The output of index engine will be a list of identifiers of candidate media contents ranked by hit-rate of similarity with sampled fingerprints of input media content.

Component 104 is the query engine, which performs VDNA fingerprint level match between each one of VDNA fingerprints ingested from input media content and all VDNA fingerprints of every candidate media content output from index engine. There are also scalability requirements for the design of query engine as the same index engine, because the number of registered media contents by content owner may vary in different magnitude, the amount of registered VDNA fingerprints can be massive. In such condition, distributed query engines are also required to enforce computing capability of the system.

The basic building block of VDNA fingerprint identification algorithm is calculation and comparison of Hamming Distance of fingerprints between input and master media contents. A score will be given after comparing input media content with each of top ranked media contents outputted by index server. A learning-capable mechanism will then help to decide whether or not the input media content is identified with reference to the identification score, media metadata, and identification history.

In order to optimize the speed and accuracy of content identification, some methods are applied also in this process, such as using triangle principle to predict some special matching scenarios, and adding timeline information or other dimensional information to improve content matching accuracy. Such optimization techniques will be introduced later.

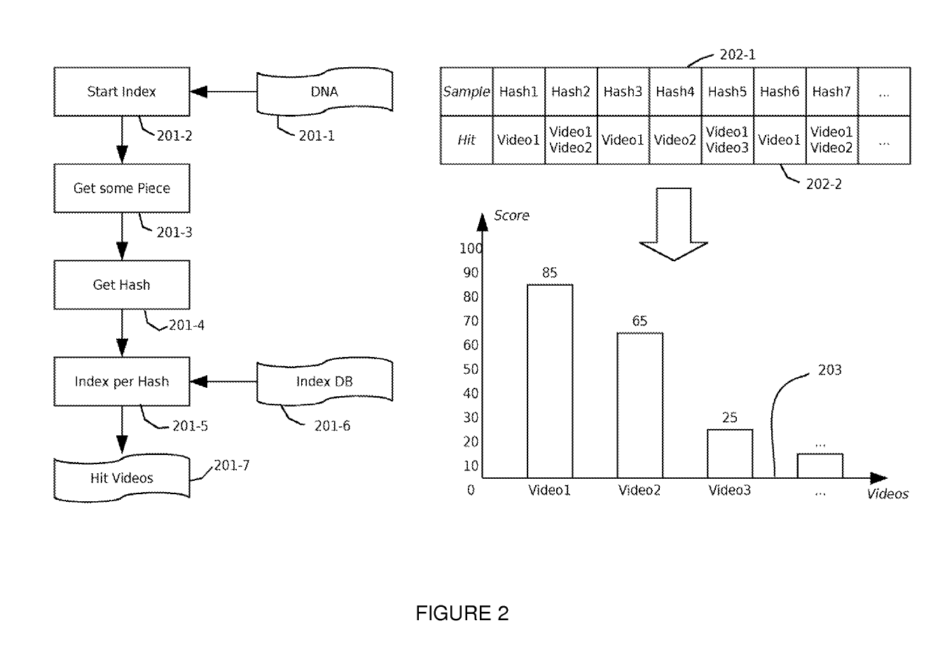

FIG. 2 illustrates the workflow and important components inside index engine. 201-1 to 201-7 demonstrate the workflow in detail: 201-1 is the VDNA fingerprints of input media content submitted along with query request; 201-2 shows that after receiving query request, index engine starts a session to process the request, it will pre-process some extra metadata information coming with the request to hopefully narrow down the scope from all registered contents to match; step 201-3 shows that the index engine retrieves a certain number of samples from the VDNA fingerprints; and then the above samples will be hashed (201-4) and indexed (201-5) with the index database (201-6) which stores a key-value mapping where the keys are hashed VDNA fingerprints of the registered master media content and the values are the identifier of the registered master media content; the output of the index engine is a list hit videos (201-7) ranked by hit scores.

Block 202-1 and 202-2 are the symbols of the indexing process of the engine. Items on the row of 202-1 represent the hashed samples of the input content fingerprints, which are indexed and hit with some items in the database of registered VDNA fingerprints. The hit result is shown in row 202-2, where there may be some overlapping hits on the same sample. The hit results are then calculated so that every hit media content has a score representing the hit rate. The first certain number of the best scored media contents or the media contents with score higher than a certain rate will be listed in order by score and output as a candidate match contents for later process.

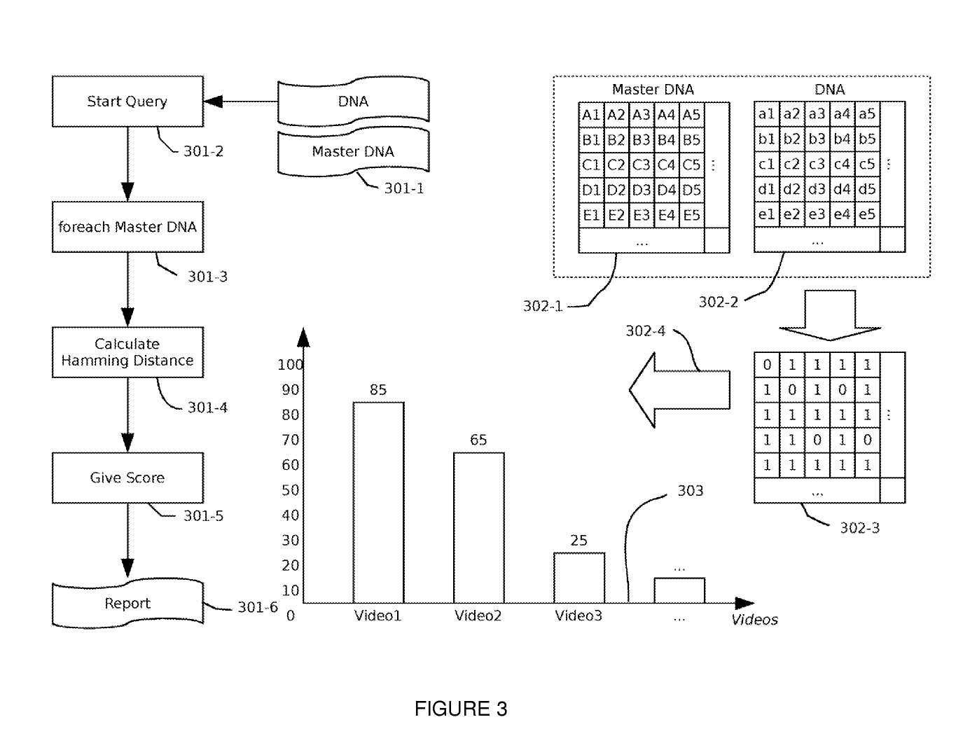

FIG. 3 illustrates the workflow and important components of query engine. 301-1 to 301-6 demonstrate the workflow in detail: 301-1 is the VDNA fingerprints of input media content submitted along with query request, and all master VDNA fingerprints of the media contents in the candidate list output from index engine; 301-2 and 301-3 show that query engine will process each one of the master VDNA fingerprints, and calculate Hamming Distance (301-4) among each one of the VDNA fingerprints of input media contents. Based on the result of such calculations, each one of the media contents in the candidate list will be given a score indicating match rate with the input media content, and a report will then be generated and analyzed.

Blocks 302-1, 302-2 and 302-3 demonstrate the Hamming Distance comparison process between a sample master VDNA fingerprint and a sample VDNA fingerprint from input media content. The result of the whole comparison process is illustrated in 303, where the media content with highest score is considered to be a most possible match. To this point, the input media content can be successfully identified.

There are some other methods to optimize the speed and accuracy of the identification process. One of them is using triangle principle on Hamming Distance to save a lot of time and efforts without calculating Hamming Distance between the sample fingerprint and a master fingerprint which can be predicted being in low score.

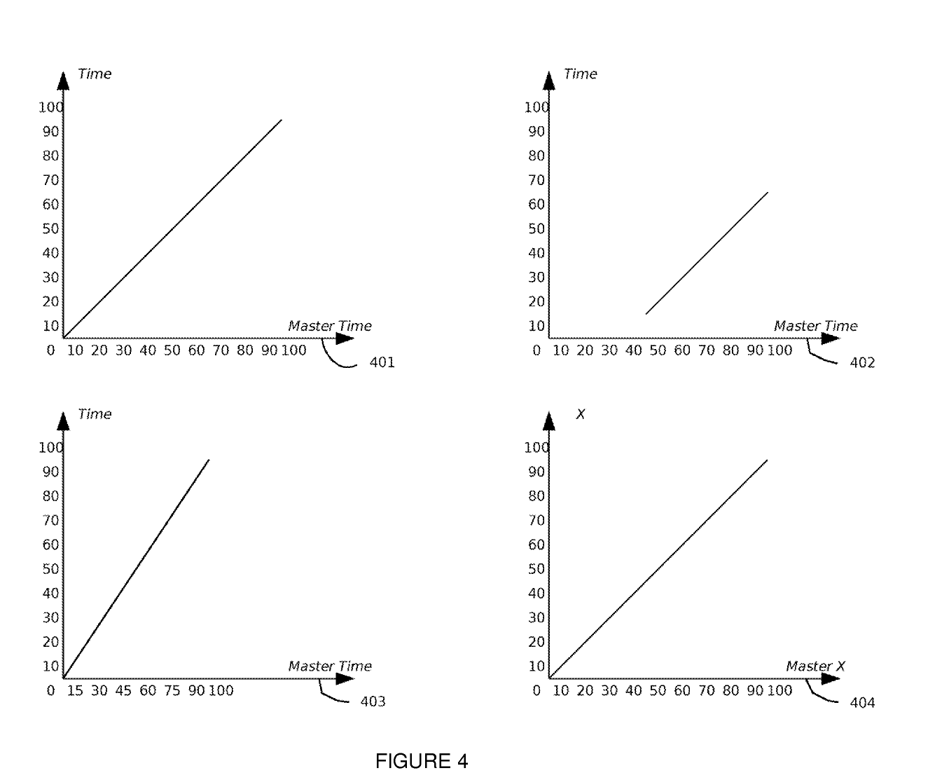

Another method to greatly improve accuracy of identification is adding information on other dimensions such as timeline, or other detail of images in the matching process, as illustrated in FIG. 4. Take timeline as an example, when matching input media content with master content using Hamming Distance, if these two contents are fully matched, the timeline relationship between input media content and master content is shown in coordinate 401. But if the input media content is incomplete or embedded with other contents, the timeline relationship will be similar to coordinate 402. In the case that the input media content is in different playback speed than the master content, the coordinate would be similar to coordinate 403. Coordinate 404 means there could be other dimensional information besides timeline information. With such extra information from additional dimensions, more status of the input media content can be deduced, so as to improve accuracy of identification.

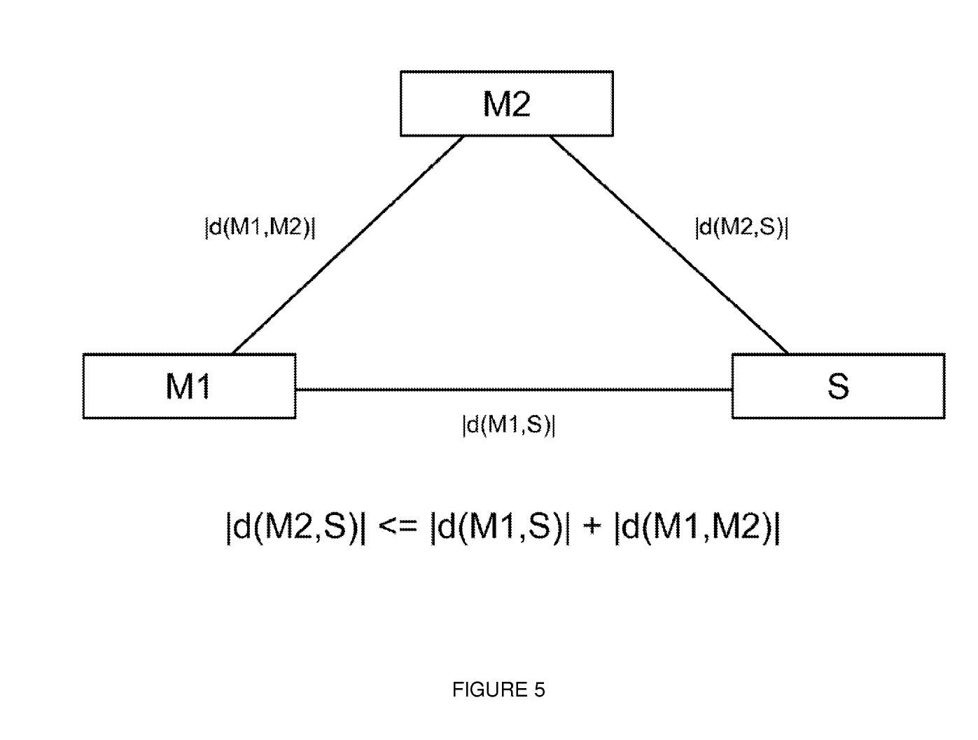

FIG. 5 illustrates basic logic of Triangle Principle: In mathematics, the triangle inequality states that for any triangle, the sum of the lengths of any two sides must be greater than or equal to the length of the remaining side. If |d(M2, S)|, |d(M1, S)| and |d(M1, M2)| are the lengths of the sides of the triangle, then the triangle inequality states that:

|d(M2,S)|<=|d(M1,S)|+|d(M1,M2)|

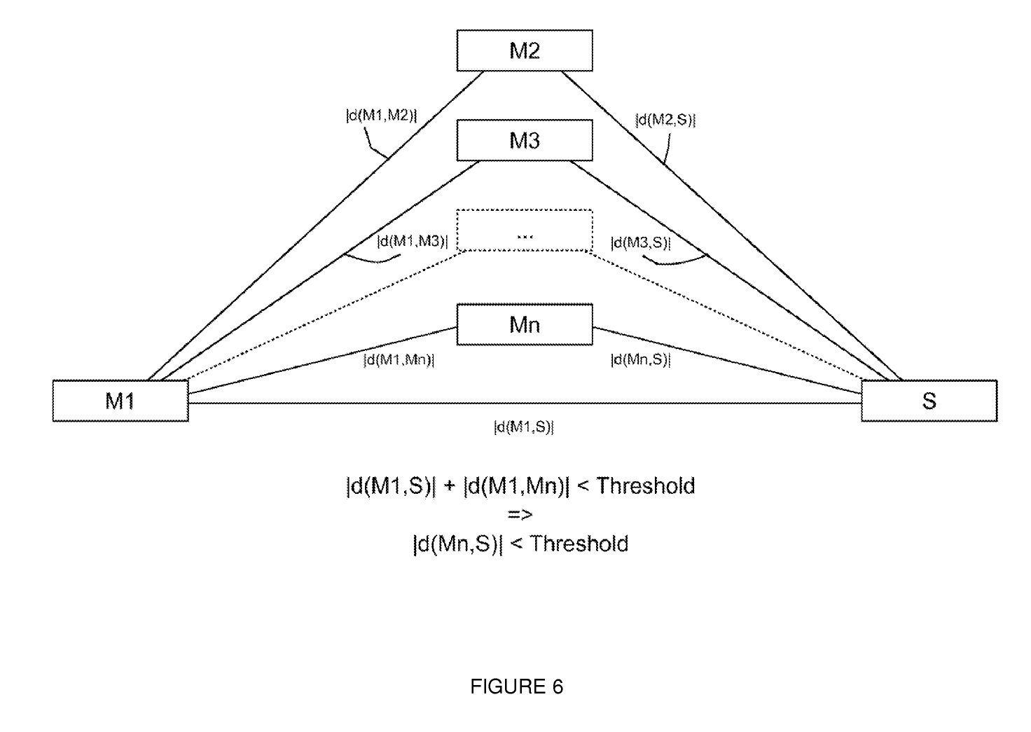

FIG. 6 depicts the application of Triangle Principle in query engines in a VDNA system. Block “S” represents a sample VDNA fingerprint. Block “M1”, “M2”, . . . “M−n” represent a list of candidate master VDNA fingerprints generated from index search. Formula |d(x, y)| represents the distance calculated by comparing VDNA fingerprint x and y.

During query processing, sample VDNA fingerprint is to compare with multiple candidates of master VDNA fingerprints. Each distance |d(M−n, S)| calculated by comparing each said pair of VDNA fingerprints is used to determine the result of query. If distance |d(M−n, S)| is below a certain threshold, master VDNA fingerprint M−n is considered matching sample VDNA fingerprint S.

However, due to compact design of VDNA fingerprint and algorithm complexity, VDNA fingerprint compare is a time consuming calculation. Triangle Principle is applied in query engines to optimize this process. According to Triangle Principle, if the distance sum of |d(M1, S)| and |d(M1, M−n)| is less than a threshold, distance |d(M−n, S)| can also be concluded less than said threshold, meaning master VDNA fingerprint M−n matches sample VDNA fingerprint S. Moreover, distances between master VDNA fingerprints M1 and M2 . . . M−n can be pre-calculated once and stored in the system, to eliminate the time cost during query process. Therefore in the time of query, the only necessary calculation between VDNA fingerprints is to determine distance between master VDNA fingerprint M1 and sample VDNA fingerprint S. With the resulting distance |d(M1, S)| from said calculation, it is considerably faster to deduce matching results between sample VDNA fingerprint S and other candidate master VDNA fingerprints M2, M3, . . . M−n. Applying Triangle Principle in query process is able to tremendously boost performance of the query engines.

Formula |d(M−n, S)|>=∥d(M1,M−n)|−|d(M1,S)∥ can be deduced from the Triangle Principle. Said formula explains that if the absolute value of the difference between the 2 distances |d(M1,M−n)| and |d(M1,S)| is equal or greater than a threshold, then the distance |d(M−n, S)| calculated between master VDNA fingerprint M−n and sample VDNA fingerprint S must be equal or greater than said threshold, which means master VDNA fingerprint M−n does not match sample VDNA fingerprint S.

The aforementioned applications of Triangle Principle can also be extended to apply in index search, where M2, M3 . . . M−n can be all registered master VDNA fingerprints, instead of the list of candidates output from index search. Using the illustrated VDNA fingerprint compare method, it is able to implement quick filtering on mass quantity of master VDNA fingerprints, so as to generate a more accurate and broader coverage candidate list.

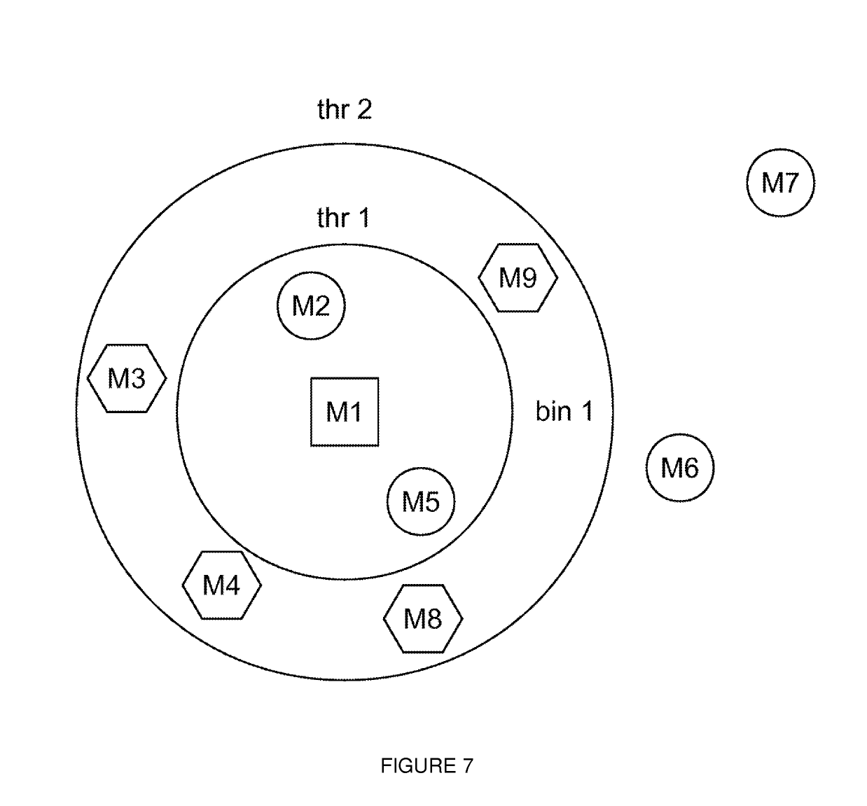

FIG. 7 illustrates possible optimization of pre-calculated distances among master VDNA fingerprints in actual implementation. Considering the mass quantity of master VDNA fingerprints, the complete result set of calculated distances |d(M−n, M−m)| is bound to grow drastically. For instance for 3 master VDNA fingerprints a, b and c, is it required to keep 3 pre-calculated distances |d(a, b)|, |d(b, c)| and |d(a, c)|, while for 4 master VDNA fingerprints 6 pre-calculated distances are required to keep, that means pre-calculated distances for n master VDNA fingerprints. Therefore in implementation, multiple bins maybe created based on different thresholds, used to categorize and store pre-calculated distances which fall into corresponded category. For example the thresholds for bin1 are thr1 and thr2, so that the set bin1 holds all master VDNA fingerprints whose distances |d(M1,Mn)| are equal or greater than thr1 and less than thr2.

In implementation, M1 may or may not be a VDNA fingerprint extracted from an actual master content, it can be constructed based on calculation of actual master VDNA fingerprint set, so as to improve performance of the algorithm using Triangle Principle. For instance, if the thresholds for bin1 are thr1 and thr2, it is a reasonable attempt to construct a VDNA fingerprint M1 so that as many as other master VDNA fingerprints can fit in this category that their distances to M1 are within thresholds thr1 and thr2.

In addition, the fingerprints M1, M2 . . . M−n should be extracted from timely equal master clips, instead of the entire master content. That is, if the length of each timely equal master clip is defined as 10 seconds, then a 10-minute master video is to be disassembled to 60 master clips, which in turn are extracted to master VDNA fingerprints M1, M2 . . . M60.

In conclusion, a Video DNA (VDNA) method and system for multi-dimensional content matching include:

A Video DNA (VDNA) method for identifying and matching content characteristics comprises ingesting the aforementioned VDNA fingerprints from input media contents and quick hash-based query across the aforementioned VDNA registered index engine, and identifying contents in query engines by using triangle principle to obtain best matched results of the aforementioned input media content.

The triangle principle is utilized for VDNA fingerprint comparison of the content identification comprising:
a) Block “5” represents a sample VDNA fingerprint. Block “M1”, “M2”, . . . “M−n” represent a list of candidate master VDNA fingerprints generated from index search. Formula |d(x, y)| represents the distance calculated by comparing VDNA fingerprint x and y,
b) if the distance sum of |d(M1, S)| and |d(M1, M−n)| is less than a threshold, distance |d(M−n, S)| can also be concluded less than the threshold, which means that master VDNA fingerprint M−n matches sample VDNA fingerprint S,
c) the |d(M1, M−n)| distances between master VDNA fingerprints M1, M2 . . . M−n can be pre-calculated once and stored in system to eliminate time cost during query process,
d) the only necessary calculation between the VDNA fingerprints is to determine the |d(M1, S)| distance between master VDNA fingerprint M1 and the sample VDNA fingerprint S, and
e) if the absolute value of difference between 2 distances of the |d(M1,M−n)| and the |d(M1,S)| is equal or greater than a threshold, then the distance |d(M−n, S)| calculated between the master VDNA fingerprint M−n and the sample VDNA fingerprint S must be equal or greater than the threshold, which means that the master VDNA fingerprint M−n does not match the sample VDNA fingerprint S.

Optimization method of pre-calculated distances among the master VDNA fingerprints in actual implementation comprising:
a) considering mass quantity of the master VDNA fingerprints, a complete result set of calculated distances |d(M−n, M−m)| is bound to grow drastically, for instance for 3 the master VDNA fingerprints a, b and c, it is required to keep 3 pre-calculated distances |d(a, b)|, |d(b, c)| and |d(a, c)|, and for 4 the master VDNA fingerprints, 6 pre-calculated distances are required to keep, which means pre-calculated distances for n the master VDNA fingerprints,
b) multiple bins are created based on different thresholds, used to categorize and store the pre-calculated distances which fall into corresponded category, for example thresholds for bin1 are thr1 and thr2, so that set bin1 holds all the master VDNA fingerprints whose distances |d(M1,Mn)| are equal or greater than thr1 but less than thr2,
c) M1 may or may not be a VDNA fingerprint extracted from an actual master content, it can be constructed based on calculation of actual master VDNA fingerprint set, so as to improve performance of algorithm by using the triangle principle, for instance, if the thresholds for the bin1 are the thr1 and the thr2, it is a reasonable attempt to construct a VDNA fingerprint M1 so that as many as other the master VDNA fingerprints can fit in this category that their distances to M1 are within thresholds of the thr1 and the thr2, and
d) fingerprints M1, M2 . . . M−n are extracted from timely equal master clips, instead of entire master content, which means, if length of each the timely equal master clip is defined as 10 seconds, then a 10-minute master video is to be disassembled to 60 the master clips, which in turn are extracted to the master VDNA fingerprints M1, M2 . . . M60.

The triangle principle can also be extended to index search, wherein the M2, M3 . . . M−n can be all registered the master VDNA fingerprints, instead of the list of candidates output from the index search.

The aforementioned input media contents can be any format of audio, video or image contents, which have characteristics matchable by algorithms based on Hamming Distance.

The aforementioned index engines are a set of database engines wherein processed aforementioned VDNA fingerprints of all registered media contents are stored as keys in database table entities.

The aforementioned index engine can be a set of distributed engines which stores hashed aforementioned VDNA fingerprints of all the aforementioned registered media contents.

The aforementioned index engine can be a set of distributed engines which are scalable and extensible as presented in volumes of the aforementioned registered media contents.

A set of samples of the aforementioned VDNA fingerprints ingested from the aforementioned input media content will be processed using hash functions to quickly match with the aforementioned keys registered in the aforementioned index engine, and the result of process will be a list of matched candidate contents ranked by matching rate with the aforementioned input media content.

The aforementioned query engine performs thorough content identification on the aforementioned VDNA fingerprints level to match the aforementioned input media content with the top ranked candidates listed by the aforementioned index engine.

The aforementioned query engine uses triangle principle to greatly increase the speed of the aforementioned content identification.

The aforementioned query engine can be a set of distributed engines which stores the aforementioned VDNA fingerprints of all the aforementioned registered media contents.

The aforementioned query engine can be a set of distributed engines which are scalable and extensible as presented in volumes of the aforementioned registered media contents.

A Video DNA (VDNA) method for identifying and matching content characteristics comprises ingesting the aforementioned VDNA fingerprints from input media contents and quick hash-based query across the aforementioned VDNA registered index engine, and performing multi-dimensional content identification in query engines to obtain best matched results of the aforementioned input media content.

The aforementioned multi-dimensional content identification means to apply information other than content fingerprints to increase speed and accuracy of the aforementioned identification.

The aforementioned multi-dimensional content identification considers media content timeline as an additional dimension to increase speed and accuracy of the aforementioned identification.

The aforementioned multi-dimensional content identification considers images and audio respectively inside a video clip as different dimensions to increase speed and accuracy of the aforementioned identification.

The aforementioned matched result can contain metadata of the matched content such as title etc, the offset of the input content as to the original registered media content, and quality of the input content, for example HD/DVD quality, VHS quality or camera quality.

With the help of identifying not only media content frame fingerprints but also the aforementioned content timeline, the aforementioned method enables identification of the aforementioned input media contents which are incomplete, modified or in various playback speeds.

A Video DNA (VDNA) system called VDDB (video DNA database) for identifying and matching content characteristics comprises subsystem ingesting the aforementioned VDNA fingerprints from input media contents and quick hash-based query across the aforementioned VDNA registered index engine, and subsystem performing multi-dimensional content identification in query engines to obtain best matched results of the aforementioned input media content.

The aforementioned VDDB comprises an interface which accepts the aforementioned VDNA fingerprints and metadata information of the aforementioned input media contents.

The aforementioned VDDB comprises distributed index servers which processes the aforementioned sampled VDNA fingerprints of the aforementioned input media content using hash functions to quickly match with the aforementioned fingerprints of master media contents registered in the aforementioned index engine, and the result of process will be a list of matched candidate contents ranked by matching rate with the aforementioned input media content.

The aforementioned VDDB comprises the aforementioned distributed query engines which performs the aforementioned complete VDNA query on each one of the top ranked candidates by using Hamming Distance as core algorithm, and timeline information to improve the aforementioned content identification speed and accuracy.

The method and system of the present invention are based on the proprietary architecture of the aforementioned VDNA® and VDDB® platforms, developed by Vobile, Inc, Santa Clara, Calif.

The method and system of the present invention are not meant to be limited to the aforementioned experiment, and the subsequent specific description utilization and explanation of certain characteristics previously recited as being characteristics of this experiment are not intended to be limited to such techniques.

Many modifications and other embodiments of the present invention set forth herein will come to mind to one ordinary skilled in the art to which the present invention pertains having the benefit of the teachings presented in the foregoing descriptions. Therefore, it is to be understood that the present invention is not to be limited to the specific examples of the embodiments disclosed and that modifications, variations, changes and other embodiments are intended to be included within the scope of the appended claims. Although specific terms are employed herein, they are used in a generic and descriptive sense only and not for purposes of limitation.

What is claimed:

1. A Video DNA (VDNA) method for identifying and matching content characteristics, said method comprising: ingesting VDNA fingerprints from both input media contents and quick hash-based query across a plurality of VDNA registered index engines storing a key-value mapping, and identifying contents in query engines by using triangle principle to obtain best matched results of said input media content and greatly increase speed of content identification,
wherein VDNA fingerprint identification is based on calculation and comparison of Hamming Distance of said VDNA fingerprints between input and master media contents, wherein said keys are hashed VDNA fingerprints of registered master media content and said values are identifiers of said registered master media content, and wherein said triangle principle is utilized for VDNA fingerprint comparison of said content identification comprising:
a) Block “S” represents a sample VDNA fingerprint. Block “M1”, “M2”, . . . “M−n” represent a list of candidate master VDNA fingerprints generated from index search. Formula |d(x, y)| represents the distance calculated by comparing VDNA fingerprint x and y,
b) if the distance sum of |d(M1, S)| and |d(M1, M−n)| is less than a threshold, distance |d(M−n, S)| can also be concluded less than said threshold, which means that master VDNA fingerprint M−n matches sample VDNA fingerprint S,
c) said |d(M1, M−n)| distances between master VDNA fingerprints M1, M2 . . . M−n can be pre-calculated once and stored in system to eliminate time cost during query process,
d) the only necessary calculation between said VDNA fingerprints is to determine said |d(M1, S)| distance between master VDNA fingerprint M1 and said sample VDNA fingerprint S, and
e) if the absolute value of difference between 2 distances of said |d(M1,M−n)| and said |d(M1,S)| is equal or greater than a threshold, then said distance |d(M−n, S)| calculated between said master VDNA fingerprint M−n and said sample VDNA fingerprint S must be equal or greater than said threshold, which means that said master VDNA fingerprint M−n does not match said sample VDNA fingerprint S.

2. The method as recited in claim 1, wherein said input media contents comprise any format of audio, video or image contents, which have characteristics matchable by algorithms based on Hamming Distance among each one of said VDNA fingerprints of input media contents.

3. The method as recited in claim 1, wherein said index engines are a set of database engines wherein processed said VDNA fingerprints of all registered media contents are stored as a key-value mapping in database table entities.

4. The method as recited in claim 1, wherein said index engine comprises a set of distributed engines which stores hashed said VDNA fingerprints of all registered media contents.

5. The method as recited in claim 1, wherein said index engine and said query engine further comprise sets of distributed engines which are scalable and extensible.

6. The method as recited in claim 1, wherein a set of samples of said VDNA fingerprints ingested from said input media content is processed using hash functions to match with keys registered in said index engine, and the result of process is a list of matched candidate contents ranked by matching rate with said input media content.

7. The method as recited in claim 1, wherein said query engine performs content identification on said VDNA fingerprints level to match said input media content with the top ranked candidates listed by said index engine.

8. The method as recited in claim 1, wherein optimization method of pre-calculated distances among said master VDNA fingerprints in actual implementation comprising:
a) considering mass quantity of said master VDNA fingerprints, a complete result set of calculated distances |d(M−n, M−m)| is bound to grow drastically, for instance for 3 said master VDNA fingerprints a, b and c, it is required to keep 3 pre-calculated distances |d(a, b)|, |d(b, c)| and |d(a, c)|, and for 4 said master VDNA fingerprints, 6 pre-calculated distances are required to keep, which means C₂ pre-calculated distances for n said master VDNA fingerprints,
b) multiple bins are created based on different thresholds, used to categorize and store said pre-calculated distances which fall into corresponded category, for example thresholds for bin1 are thr1 and thr2, so that set bin1 holds all said master VDNA fingerprints whose distances |d(M1,Mn)| are equal or greater than thr1 but less than thr2,
c) M1 may or may not be a VDNA fingerprint extracted from an actual master content, it can be constructed based on calculation of actual master VDNA fingerprint set, so as to improve performance of algorithm by using said triangle principle, for instance, if said thresholds for said bin1 are said thr1 and said thr2, it is a reasonable attempt to construct a VDNA fingerprint M1 so that as many as other said master VDNA fingerprints can fit in this category that their distances to M1 are within thresholds of said thr1 and said thr2, and
d) fingerprints M1, M2 . . . M−n are extracted from timely equal master clips, instead of entire master content, which means, if length of each said timely equal master clip is defined as 10 seconds, then a 10-minute master video is to be disassembled to 60 said master clips, which in turn are extracted to said master VDNA fingerprints M1, M2 . . . M60.

9. The method as recited in claim 1, wherein said query engine comprises a set of distributed engines which stores said VDNA fingerprints of all said registered media contents.

10. The method as recited in claim 1, wherein said triangle principle can also be extended to index search, wherein said M2, M3 . . . M−n can be all registered said master VDNA fingerprints, instead of said list of candidates output from said index search.

11. A Video DNA (VDNA) method for identifying and matching content characteristics, said method comprising: ingesting VDNA fingerprints from both input media contents and quick hash-based query across a plurality of VDNA registered index engines storing a key-value mapping, and performing multi-dimensional content identification in query engines by using triangle principle to obtain best matched results of said input media content and greatly increase speed of content identification,
wherein VDNA fingerprint identification is based on calculation and comparison of Hamming Distance of said VDNA fingerprints between input and master media contents, wherein said keys are hashed VDNA fingerprints of registered master media content and said values are identifiers of said registered master media content, and wherein said triangle principle is utilized for VDNA fingerprint comparison of said content identification comprising:
a) Block “S” represents a sample VDNA fingerprint. Block “M1”, “M2”, . . . “M−n” represent a list of candidate master VDNA fingerprints generated from index search. Formula |d(x, y)| represents the distance calculated by comparing VDNA fingerprint x and y,
b) if the distance sum of |d(M1, S)| and |d(M1, M−n)| is less than a threshold, distance |d(M−n, S)| can also be concluded less than said threshold, which means that master VDNA fingerprint M−n matches sample VDNA fingerprint S,
c) said |d(M1, M−n)| distances between master VDNA fingerprints M1, M2 . . . M−n can be pre-calculated once and stored in system to eliminate time cost during query process,
d) the only necessary calculation between said VDNA fingerprints is to determine said |d(M1, S)| distance between master VDNA fingerprint M1 and said sample VDNA fingerprint S, and
e) if the absolute value of difference between 2 distances of said |d(M1,M−n)| and said |d(M1,S)| is equal or greater than a threshold, then said distance |d(M−n, S)| calculated between said master VDNA fingerprint M−n and said sample VDNA fingerprint S must be equal or greater than said threshold, which means that said master VDNA fingerprint M−n does not match said sample VDNA fingerprint S.

12. The method as recited in claim 11, wherein said multi-dimensional content identification comprises method to apply timeline in additional to VDNA fingerprints to increase speed and accuracy of said identification.

13. The method as recited in claim 11, wherein said multi-dimensional content identification considers images and audio respectively inside a video clip as different dimensions to increase speed and accuracy of said identification.

14. The method as recited in claim 11, wherein said multi-dimensional content identification considers media content timeline as an additional dimension to increase speed and accuracy of said identification.

15. The method as recited in claim 11, further comprising identifying not only media content frame fingerprints but also content timeline, said method enables identification of said input media contents which are incomplete, modified or in different playback speeds from master content.

16. The method as recited in claim 11, wherein said matched result comprises matched content title, an offset of said input media content as to an original registered media content, and quality of said input media content.

17. A Video DNA (VDNA) system for identifying and matching content characteristics, said system comprising: a sub-processor ingesting VDNA fingerprints from both input media contents and quick hash-based query across a plurality of VDNA registered index engines storing a key-value mapping in memory, and said sub-processor performing multi-dimensional content identification in query engines by using triangle principle to obtain best matched results of said input media content and greatly increase speed of content identification,
wherein VDNA fingerprint identification is based on calculation and comparison of Hamming Distance of said VDNA fingerprints between input and master media contents, wherein said keys are hashed VDNA fingerprints of registered master media content and said values are identifiers of said registered master media content, and wherein said triangle principle is utilized for VDNA fingerprint comparison of said content identification comprising:
a) Block “S” represents a sample VDNA fingerprint. Block “M1”, “M2”, . . . “M−n” represent a list of candidate master VDNA fingerprints generated from index search. Formula |d(x, y)| represents the distance calculated by comparing VDNA fingerprint x and y,
b) if the distance sum of |d(M1, S)| and |d(M1, M−n)| is less than a threshold, distance |d(M−n, S)| can also be concluded less than said threshold, which means that master VDNA fingerprint M−n matches sample VDNA fingerprint S,
c) said |d(M1, M−n)| distances between master VDNA fingerprints M1, M2 . . . M−n can be pre-calculated once and stored in system to eliminate time cost during query process,
d) the only necessary calculation between said VDNA fingerprints is to determine said |d(M1, S)| distance between master VDNA fingerprint M1 and said sample VDNA fingerprint S, and
e) if the absolute value of difference between 2 distances of said |d(M1,M−n)| and said |d(M1,S)| is equal or greater than a threshold, then said distance |d(M−n, S)| calculated between said master VDNA fingerprint M−n and said sample VDNA fingerprint S must be equal or greater than said threshold, which means that said master VDNA fingerprint M−n does not match said sample VDNA fingerprint S.

18. The system as recited in claim 17, wherein said VDNA system comprises an interface memory which accepts said VDNA fingerprints and metadata information of said input media contents.

19. The system as recited in claim 17, wherein said VDNA system comprises distributed index servers which process sampled said VDNA fingerprints of said input media content using hash functions to quickly match with said fingerprints of master media contents registered in said index engines, and the result of process is a list of matched candidate contents ranked by matching rate with said input media content.

20. The system as recited in claim 17, wherein said VDNA system comprises said query engines which perform complete VDNA query on each one of the top ranked candidates by using Hamming Distance as a core algorithm, to calculate timeline information to improve content identification speed and accuracy.
